(19) United States
(12) Patent Application Publication
(10) Pub. No.: US 2007/0083401 A1
(43) Pub. Date: Apr. 12, 2007

(54) Travel and expense management

(76) Inventors: Andreas Vogel, San Francisco, CA (US); Hendrik Vordenbaeumen, Bad Schoenborn (DE)

Correspondence Address: KENYON & KENYON LLP, RIVERPARK TOWERS, SUITE 600, 333 W. SAN CARLOS ST., SAN JOSE, CA, 95110, US

(21) Appl. No.: 11/248,946

(22) Filed: Oct. 11, 2005

(51) Int. Cl. G06Q 10/00

(52) U.S. Cl. 705/5

(57) ABSTRACT

A travel and expense management is proposed that runs on a computer system. A business calendar system receives travel data for a trip from an employee user. The travel data is transmitted from the business calendar system to a travel service retention system using a conduit software program. The travel service retention system books one or more travel services for the trip. A confirmation notice is sent to the employee user.

### BACKGROUND

The present invention relates to a system for managing travel and, in particular, to linking travel service retention software to a business calendar software system.

A business calendar system is a system for tracking business events. The business calendar system may include a calendar to chronologically plot business events, an address book for tracking contacts, and an e-mail system to allow communication with other users. The business calendar system may be implemented in several instances for several different users, including both employee users and management users. An example of a business calendar system is Microsoft Outlook® or Lotus Notes®. The business calendar system may have multiple presences for a single user, allowing the same calendar and e-mail information to be stored on multiple devices, such as a desktop computer, a laptop computer, or a personal digital assistant (PDA).

FIG. 1 illustrates in a block diagram one embodiment of a standard graphical user interface (GUI) 100 of a business calendar system when using the calendar function. The GUI may include a standard pull down menu 110 and toolbar 120. A file tree menu 130 may be used to select whose calendar the user views and to switch between calendar functions and other functions. A search engine 140 allows the calendar system to be searched based on date, event, or other criteria. The GUI 100 may include a calendar overview 150 to select between time periods and a calendar detail view 160 to show particular events for the time period. A task pad 170 allows the user to enter specific tasks or read specific tasks for the time period.

FIG. 2 illustrates in a block diagram one embodiment of a standard GUI 200 of a business calendar system when using the mailer function. The GUI may include the same standard pull down menu 210 and toolbar 220 as the calendar function. A file tree menu 230 may be used to select which mailbox to view and to switch between calendar functions and other functions. A search engine 240 allows the mailbox system to be searched based on date, event, sender, subject line, or other criteria. The GUI 200 may include list view 250 to show a listing of the emails in a mailbox. The GUI 200 may also show a mail preview 260 displaying the contents a selected piece of email.

The travel service retention system may electronically reserve travel services, such as travel reservations (e.g., airline, bus, and train), lodging reservations (e.g., hotels), local transportation reservations (e.g., rental cars). Examples of a travel service retention system are Sabre® and Amadeus®, which reserve airline flights. These travel service retention systems are normally accessed through an agent, be it a human travel agent or an electronic agent such as Orbitz® or Expedia®. These agents usually require a processing fee.

### BRIEF DESCRIPTION OF THE DRAWINGS

FIG. 1 illustrates in a block diagram one embodiment of a standard graphical user interface of a business calendar system when using the calendar function according to the prior art.

FIG. 2 illustrates in a block diagram one embodiment of a standard graphical user interface of a business calendar system when using the mailer function according to the prior art.

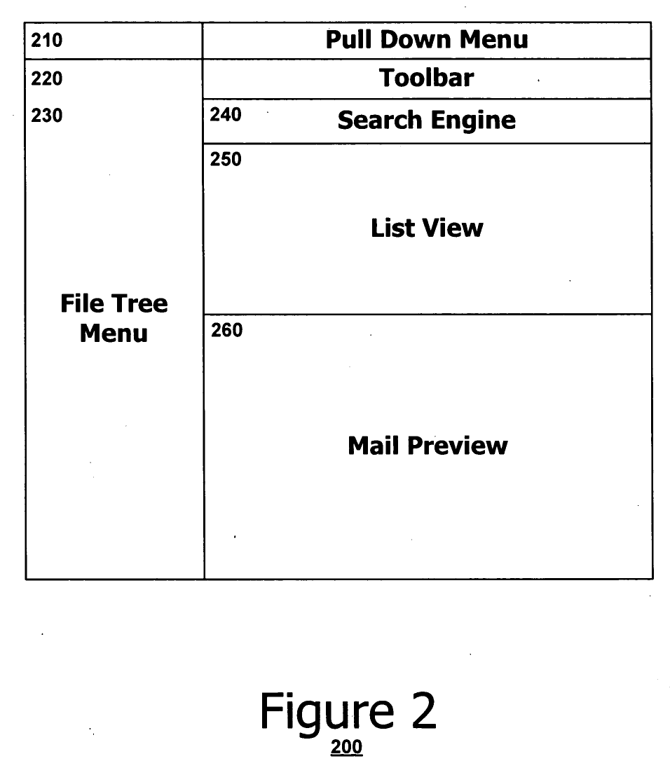

FIG. 3 illustrates a possible configuration of a computer system 300 to execute the present invention.

FIG. 4 illustrates in a block diagram one embodiment of a travel and expense management system according to the present invention.

FIG. 5 illustrates in a flowchart one embodiment of the method for transferring travel data to the travel service retention system according to the present invention.

FIG. 6 illustrates in a block diagram one embodiment of a popup window for entering travel data.

FIG. 7 illustrates in a block diagram one embodiment of the employee trip request window according to the present invention.

FIG. 8 illustrates in a flowchart one embodiment of a method 800 for granting permission for a vacation trip request through the business calendar system according to the present invention.

FIG. 9 illustrates in a block diagram one embodiment of the management trip request window according to the present invention.

FIG. 10 illustrates in a block diagram one embodiment of the employee notification window according to the present invention.

FIG. 11 illustrates one embodiment of an away mode window according to the present invention.

FIG. 12 illustrates one embodiment of a method of expense reporting according to the present invention.

FIG. 13 illustrates in a block diagram one embodiment of a method for the collection of the expenses according to the present invention.

### DETAILED DESCRIPTION

A travel and expense management is proposed that runs on a computer system. A business calendar system receives travel data for a trip from an employee user. The travel data is transmitted from the business calendar system to a travel service retention system using a conduit software program, such as the SAP® backend functionality system. The travel service retention system books one or more travel services for the trip. A confirmation notice is sent to the employee user.

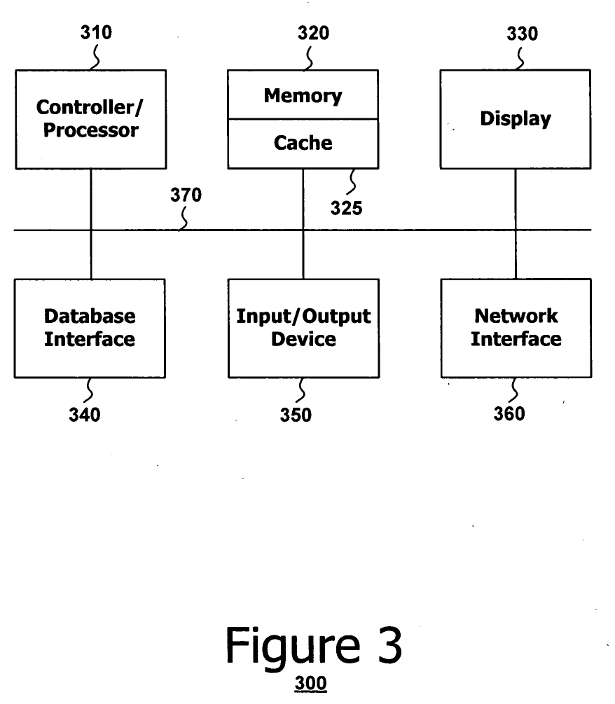

FIG. 3 illustrates a possible configuration of a computer system 300 to execute the present invention. The computer system 300 may include a controller/processor 310, a memory 320 with a cache 325, display 330, database interface 340, input/output device interface 350, and network interface 360, connected through bus 370.

The controller/processor 310 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The Input/Output interface 350 may be connected to one or more input devices that may include a keyboard, mouse, pen-operated touch screen or monitor, voice-recognition device, or any other device that accepts input. The Input/Output interface 350 may also be connected to one or more output devices, such as a monitor, printer, disk drive, speakers, or any other device provided to output data.

The memory 320 may include volatile and nonvolatile data storage, including one or more electrical, magnetic or optical memories such as a RAM, cache, hard drive, CD-ROM drive, tape drive or removable storage disk. The memory may have a cache 325 to speed access to specific data.

The network interface 360 may be connected to a communication device, modem, network interface card, or any other device capable of transmitting and receiving signals over a network. The components of the computer system 200 may be connected via an electrical bus 170, for example, or linked wirelessly.

Client software and databases may be accessed by the controller/processor 310 from memory 320 or through the database interface 340, and may include, for example, database applications, word processing applications, the client side of a client/server application such as a billing system, as well as components that embody the decision support functionality of the present invention. The computer system 300 may implement any operating system, such as Windows or UNIX, for example. Client and server software may be written in any programming language, such as ABAP, C, C++, Java or Visual Basic, for example.

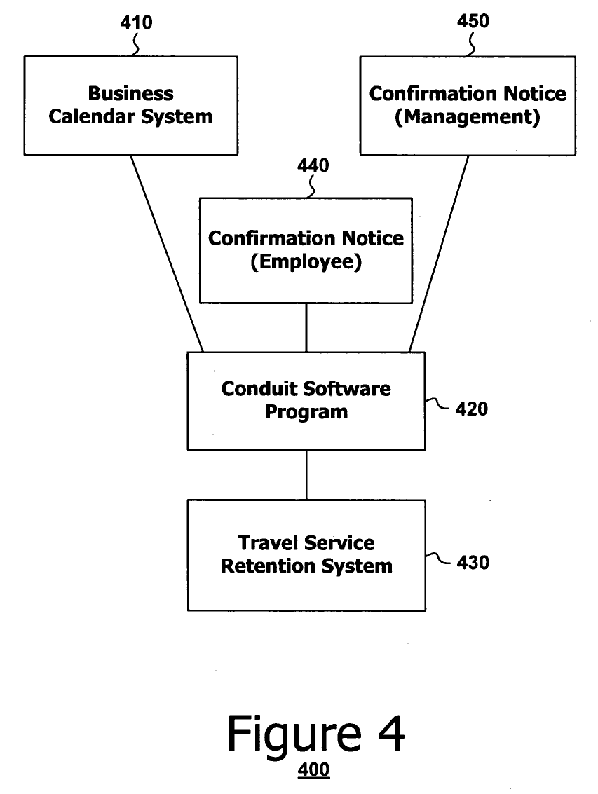

FIG. 4 illustrates in a block diagram one embodiment of a travel and expense management system 400. A user may enter travel data associated with a trip into a business calendar system 410. The user may enter a billing code identifying if the trip is a business trip or a personal vacation. This travel data may include a start date, a return date, and a destination. The business calendar system 410 may have multiple instances for a management user or for an employee user. A conduit software program 420 may harvest the travel data from the business calendar system 410 and send that data to a travel service retention system 430. The travel service retention system 430 may electronically reserve travel services, such as travel reservations (e.g., airline, bus, and train), lodging reservations (e.g., hotels), local transportation reservations (e.g., rental cars). The user may set up preferences as to which travel services the travel service retention system selects. The conduit software program may then send a confirmation notice 440 to the user. Upon acceptance of the confirmation notice 440 by the user, a record corresponding to a travel event of the trip may be inserted into the business calendar system 410. The travel event may include a departure, an arrival, check in, or rental pick up. The record may also include the name of a travel service provider associated with the event, as well as any numeric identifiers associated with the event, such as a flight number. The record may identify a date and time for the travel event. Travel event data may then be displayed by the business calendar system in the calendar detail view 160, available to the employee user on any device on which the business calendar system 410 has a presence. The confirmation notice 440 may also include a pre-populated expense report. The user may edit or adjust the pre-populated expense report to match the events of the planned trip. A second confirmation notice 450 may then be sent to a second person or group. The second confirmation notice may include the edited expense report. The user or a system manager may designate the second person or group. The second person may be a supervisor or manager of the user.

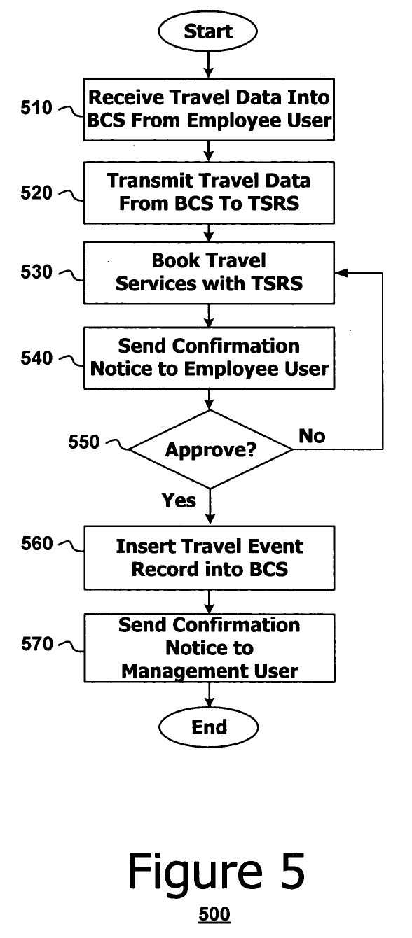

FIG. 5 illustrates in a flowchart one embodiment of the method for transferring travel data to the travel service retention system. The conduit software program 420 receives travel data associated with a specific trip via a business calendar system (BCS) 410 (Block 510). The travel data is then transmitted from the BCS 410 to the travel service retention system (TSRS) 430 (Block 520). The TSRS 430 books the travel services specified in the user preferences (Block 530). The conduit software program 420 then sends a confirmation notice to the employee user (Block 540). If the employee user does not approve (Block 550), the TSRS 430 attempts to rebook the travel services (Block 530). If the employee user does approve (Block 550), then the conduit software program 420 inserts a travel event record into the BCS 410 (Block 560). A confirmation notice may also be sent to the management user (Block 570).

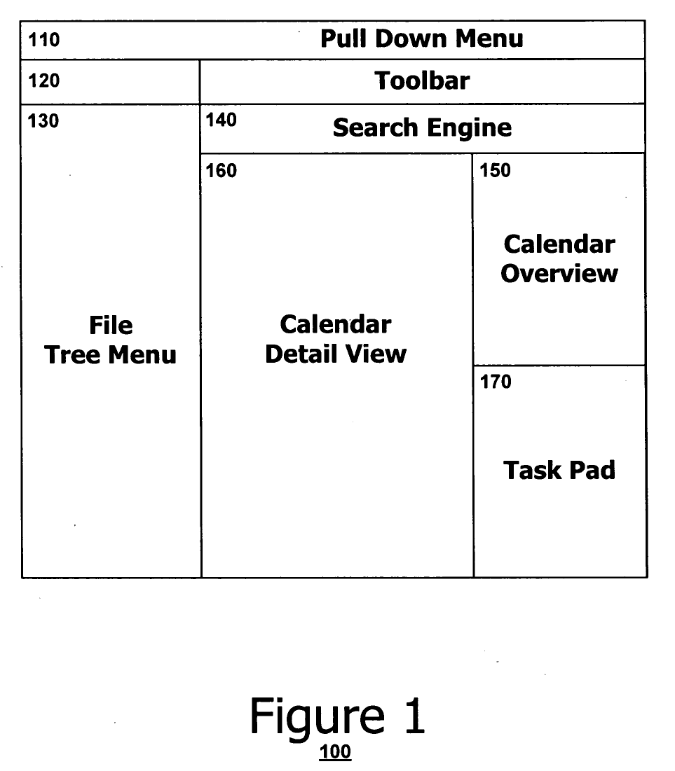

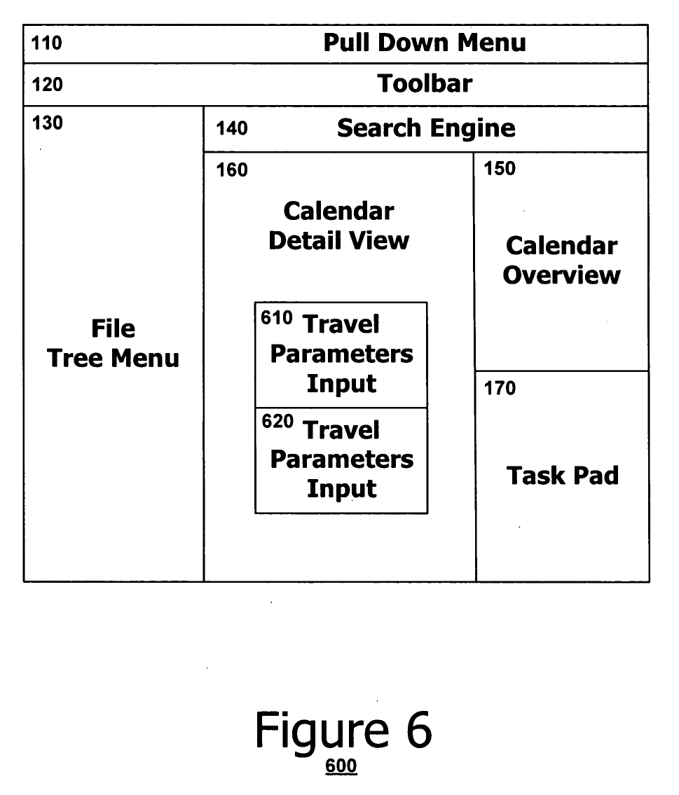

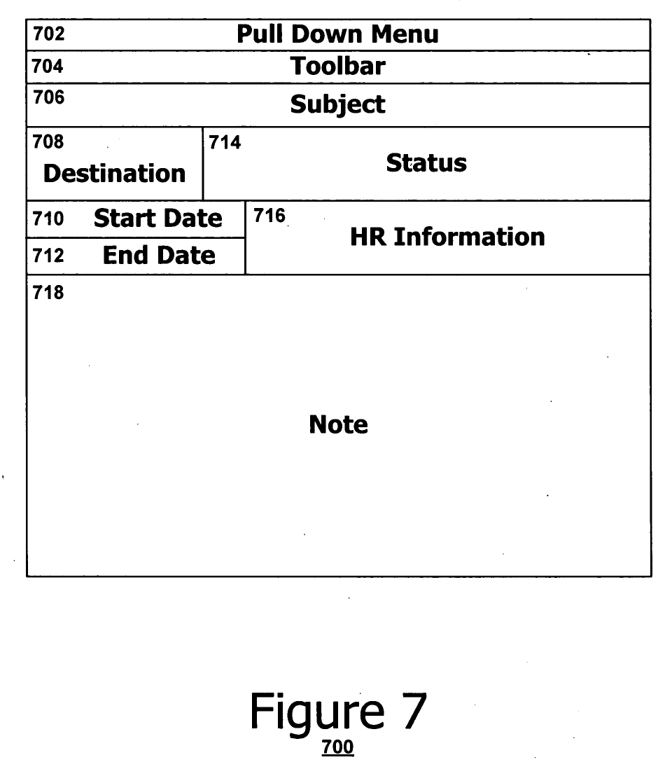

FIG. 6 illustrates in a block diagram one embodiment of a popup window 600 in the GUI 300 of FIG. 1 created by the conduit software system 420. The pop-up window 600 may include a travel parameters option 610 or a user preferences option 620. When the travel parameters option 610 is selected, a new window 700, shown in FIG. 7, may be generated allowing the user to request a vacation and enter the travel data related to that trip. When the user preferences option 620 is selected, a new window may be generated allowing the user to establish common trip parameters, such as preferred airline, hotel, or rental car.

FIG. 7 illustrates in a block diagram one embodiment of the employee trip request window 700. The employee trip request window may include a standard pull down menu 702 and toolbar 704. A subject entry field 706 may be used to enter a brief subject description. Trip parameters may be entered into a destination entry field 708, a start date entry field 710, and an end date entry field 712. A status field 714 may indicate the status of the trip request. A human resources (HR) information field 716 may be used to signify relevant HR data such as number of available vacation days. The employee user may enter an explanation of the trip in a note field 718. Alternatively for business trips, the employee user may enter a client and project number into the note field.

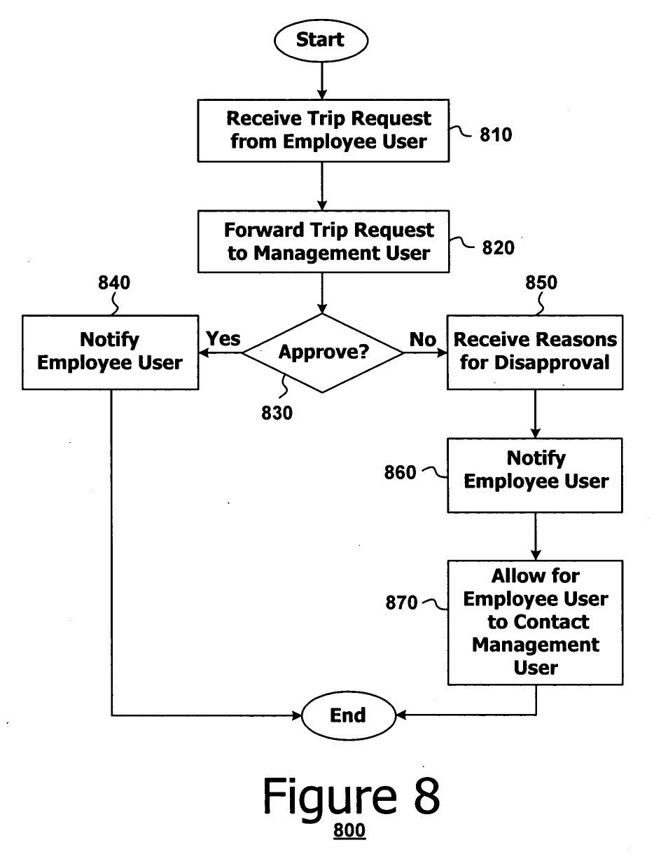

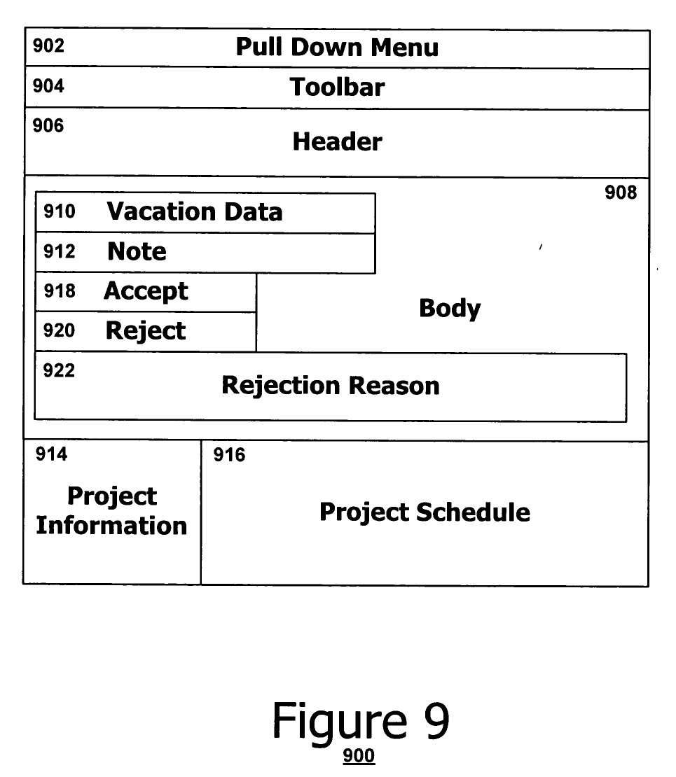

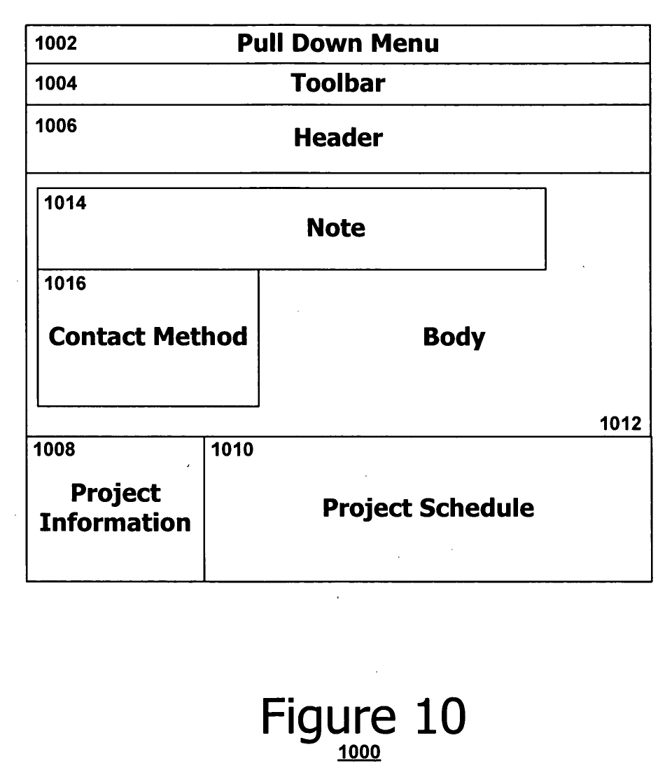

For personal vacations, the system 400 may be used to arrange vacations so that each employee is efficiently used. FIG. 8 illustrates in a flowchart one embodiment of a method 800 for granting permission for a vacation trip request through the BCS 410. The BCS 410 receives the trip request from the employee user (Block 810). In one embodiment, the BCS 410 receives the trip request via the employee trip request window 700 shown in FIG. 7. The software conduit program 420 forwards the trip request to a management user (Block 820). In one embodiment, the software conduit program 420 forwards the trip request via the management trip request window 900 shown in FIG. 9. If the management user approves the trip (Block 830), then the employee user is notified (Block 840). If the management user does not approve the trip (Block 830), then the management user's instance of the BCS 410 receives a reason for disapproval from the management user (Block 850). The employee user is notified (Block 860). In one embodiment, the software conduit program 420 notifies the employee user via the employee notification window 1000 shown in FIG. 10. The software conduit program 420 may allow the employee user to contact the management user (Block 870).

FIG. 9 illustrates in a block diagram one embodiment of the management trip request window 900. The management trip request window may include a standard pull down menu 902 and toolbar 904. A header 906 may provide a brief subject description. The body 908 of the window 900 may include the vacation data 910 and the note 912 from the employee user. Project information 914 and a project schedule 916 for the employee user may be displayed. The management user may click an accept button 918 or a reject button 920. If the management user clicks the reject button 920, a reason for the rejection 922 may be entered.

FIG. 10 illustrates in a block diagram one embodiment of the employee notification window 1000. The management trip request window may include a standard pull down menu 1002 and toolbar 1004. A header 1006 may provide a brief subject description. Project information 1008 and a project schedule 1010 for the employee user may be displayed. The body 1012 of the window may include a note 1014 from the manager explaining his decision and a method of contacting the management user 1016.

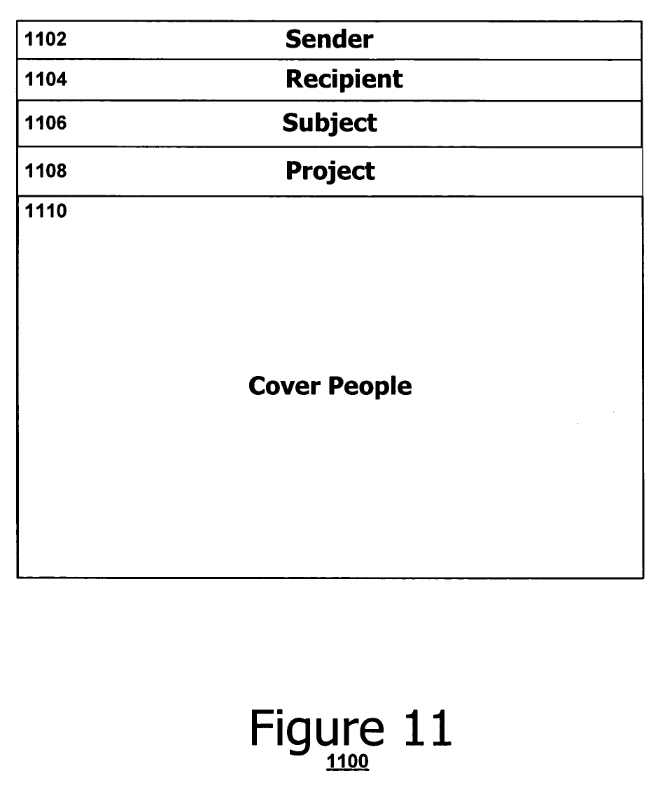

If the trip is approved, the BCS 410 may be set to an away mode that redirects e-mails. FIG. 11 illustrates one embodiment of an away mode window 1100. The away mode window may include a sender entry field 1102, a recipient entry field 1104, a subject entry field 1106, and a project entry field 1108. If an e-mail is received meeting one of these entry fields, the e-mail is forwarded to a designated cover person 1110.

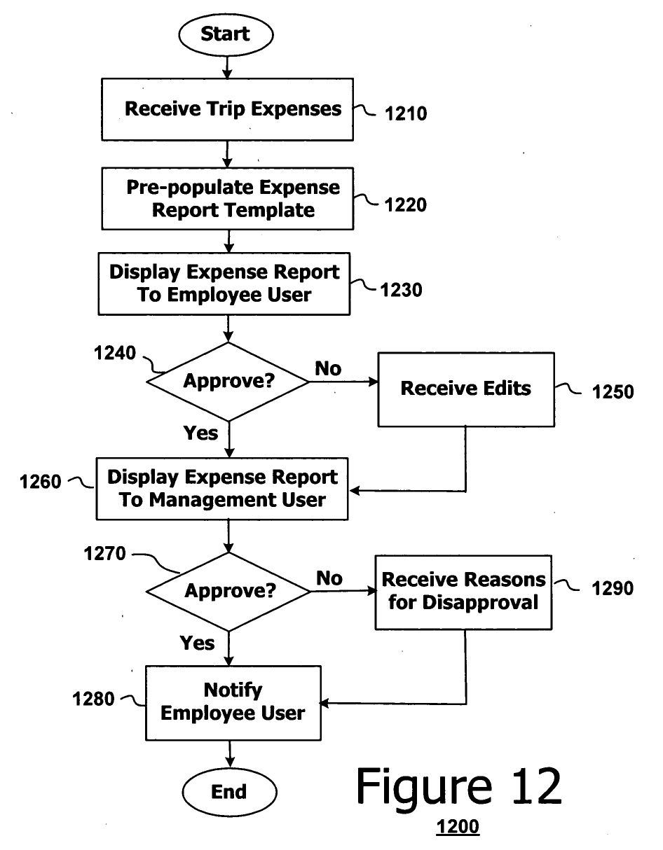

For business trips, the system 400 may automatically create an expense report for the trip. FIG. 12 illustrates one embodiment of a method of expense reporting 1200 according to the present invention. The conduit software program 420 receives the trip expenses via one or more avenues (Block 1210). The conduit software program 420 pre-populates an expense report template (Block 1220). The conduit software program 420 displays the expense report template to the employee user via the BCS 410 (Block 1230). If the employee user does not approve (Block 1240), the employee user may edit the report (Block 1250). Once the employee user approves the expense report (Block 1240), the expense report is displayed via the BCS 410 to the management user (Block 1260). If the management user approves the expense report (Block 1270), the employee user is notified (Block 1280). If the management user does not approve the expense report (Block 1270), the management user enters the reasons for disapproval (Block 1290) and the employee user is notified (Block 1280).

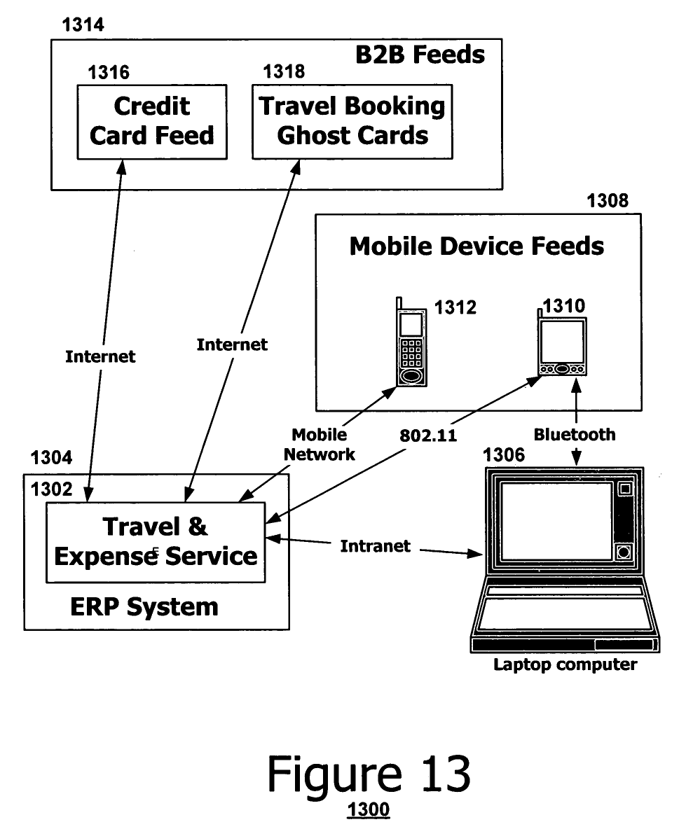

FIG. 13 illustrates in a block diagram one embodiment of the collection of the expenses 1300. The travel and expense management system 1302 may be run on an enterprise resource planning (ERP) system 1304. The employee user may record the expenses for the trip on a laptop computer 1306, which transfers the records to the travel and expense management system 1302 via an intranet. The employee user may record the expenses for the trip on a set of mobile devices 1308. The mobile devices 1308 may include a palmtop computer 1310, which may transfer the records to the laptop computer via a Bluetooth connection or to the travel and expense management system 1302 via an 802.11 connection. The mobile devices 1308 may also include a mobile telephone with digital camera 1312, which may transfer the records to the travel and expense management system 1302 via a mobile network. The travel and expense management system 1302 may receive record of the expenses for the trip via business to business (B2B) feeds 1314. The B2B feeds 1314 may include a credit card feed 1316 or a travel booking ghost card 1318, which may transfer the records to the travel and expense management system 1302 via the internet.

Several embodiments of the present invention are specifically illustrated and described herein. However, it will be appreciated that modifications and variations of the present invention are covered by the above teachings and within the purview of the appended claims without departing from the spirit and intended scope of the invention.

1. In a computer system, a method comprising:
receiving from an employee user travel data for a trip via a business calendar system;
transmitting the travel data from the business calendar system to a travel service retention system using a conduit software program; and
booking one or more travel services with the travel service retention system for the trip.

2. The method of claim 1, further comprising sending a confirmation notice to the employee user and a management user.

3. The method of claim 1, further comprising storing a record in the business calendar system corresponding to a travel event in the trip.

4. The method of claim 3, wherein the record identifies at least one of a date, time, or travel service provider for the travel event.

5. The method of claim 1, further comprising:
pre-populating an expense report template based on the trip to create an expense report;
displaying the expense report to the employee user; and
receiving a finalized version from the employee user.

6. The method of claim 5, further comprising:
receiving a list of expenses incurred during the trip; and
using the list of expenses to pre-populate the expense report template.

7. The method of claim 6, wherein the list of expenses is received from one of a phone, a digital camera, a personal digital assistant, a credit card company database, or a travel booking ghost card.

8. The method of claim 7, further comprising:
displaying the pre-populated expense report template to a management user; and
receiving approval from the management user.

9. A set of instructions residing in a storage medium, said set of instructions capable of being executed by a storage controller to implement a method for processing data, the method comprising:
receiving from an employee user travel data for a trip via a business calendar system;
transmitting the travel data from the business calendar system to a travel service retention system using a conduit software program; and
booking one or more travel services with the travel service retention system for the trip.

10. The set of instructions of claim 9, further comprising storing a record in the business calendar system corresponding to a travel event in the trip.

11. The set of instructions of claim 9,further comprising:
pre-populating an expense report template based on the trip to create an expense report;
displaying the expense report to the employee user, and
receiving a finalized version from the employee user.

12. The set of instructions of claim 11, further comprising:
receiving from a list of expenses incurred during the trip; and
using the list of expenses to pre-populate the expense report template.

13. The set of instructions of claim 12, wherein the list of expenses is received from one of a phone, a digital camera, a personal digital assistant, a credit card company database, or a travel booking ghost card.

14. The set of instructions of claim 13, further comprising:
displaying the pre-populated expense report template to a management user; and
receiving approval from the management user.

15. A computer system comprising:
an input/output port to connect the computer system to a travel service retention system; and
a processor to execute:
a business calendar system to receive from an employee user travel data for a trip; and
a conduit software program to transmit the travel data from the business calendar system to the travel service retention system, and to book one or more travel services with the travel service retention system for the trip.

16. The computer system of claim 15, wherein the conduit software program sends a confirmation notice to the employee user and a management user.

17. The computer system of claim 15, wherein the conduit software program pre-populates an expense report template based on the trip to create an expense report, displays the expense report to the employee user, and receives a finalized version from the employee user.

18. The computer system of claim 17, wherein the conduit software program receives a list of expenses incurred during the trip, and uses the list of expenses to pre-populate the expense report template.

19. The computer system of claim 18, wherein the list of expenses is received from one of a phone, a digital camera, a personal digital assistant, a credit card company database, or a travel booking ghost card.

20. The computer system of claim 19, wherein the conduit software program displays the pre-populated expense report template to a management user, and receives approval from the management user.
